(19) United States
(12) Patent Application Publication
(10) Pub. No.: US 2026/0105181 A1
(43) Pub. Date: Apr. 16, 2026

(54) SYSTEM AND METHOD FOR MAINTAINING USER PRIVACY IN REVERSE PERSONAL INFORMATION SEARCHES

(71) Applicant: Gen Digital Inc., Tempe, AZ (US)

(72) Inventors: Iskander Sanchez, Redwood City, CA (US); Beyza Bozdemir, Issy-les-Moulineaux (FR)

(73) Assignee: Gen Digital Inc., Tempe, AZ (US)

(21) Appl. No.: 18/917,460

(22) Filed: Oct. 16, 2024

(51) Int. Cl. G06F 21/62; G06F 21/60; H04L 9/00

(52) U.S. Cl. CPC G06F 21/6245; G06F 21/602; G06F 21/6227; H04L 9/008

(57) ABSTRACT

Systems and methods for maintaining user privacy in reverse personal information searches are disclosed. A user seeking to search a network (such as the Internet) for instances of one or more digital assets belonging to the user uploads the digital assets to the server system where they are stored in a secure, encrypted storage. A threshold value defines how similar a located digital asset must be to an original digital asset in order to be considered a match. The server system assembles queries to search for unauthorized instances of the user's digital assets and performs the search. Located assets and their locations (URL, IP address, etc.) are stored for access and viewing by the authorized user. Uploaded digital assets and search results are encrypted so that the operator of the server system cannot view the original digital assets or the search results to further protect the authorized user's privacy.

### FIELD

The present invention relates generally to safeguarding the personal information, reputation, and identity of users of computer networks and digital communication devices, and more specifically to a system and method for maintaining user privacy while allowing users to search for unauthorized or unwanted digital representations of their personal information.

### BACKGROUND

Computers and digital devices are valuable tools in large part for their ability to communicate with other computer systems and devices and retrieve information over computer networks. Computer networks typically comprise an interconnected group of computers, servers, and digital devices, linked by wire, fiber optic, radio, or other data transmission means, to provide the ability to transfer information between the interconnected computers, servers, and devices. The Internet is perhaps the best-known wide-area network, enabling millions of users to access millions of other computers or devices, by using computers or handheld devices such as cell phones and tablet devices, by viewing web pages, sending text messages, sending e-mail, using dedicated applications, or by performing other computer-to-computer communication.

However, because the reach of the Internet is so large and information accessible over the Internet is stored or saved in multiple locations, it is not uncommon for third parties to obtain access to other users'personal information and to use that information for unauthorized or malicious purposes. For example, most people have a digital footprint across the entire Internet comprising various personal information in digital format, such as photographs, personal information, signatures and other biometric information, voice recordings, videos, and the like. While the original posting or uploading of the personal information may have been approved or authorized by the user—e.g., social media postings of photographs or videos, or uploading a digitally signed document to a third-party website—once posted or uploaded and transmitted across the Internet, that information is potentially accessible to third parties that may copy and exploit the information for their own benefit.

For example, a malicious third-party may copy a user's photograph and digitized signature and present it as their own in an attempt to steal the user's identity or to defraud the user or another third party by impersonating the user. Or, a malicious third-party may contact others via computer, phone, text, email, instant messaging, or via other apps or services, purporting to be the original user and use copied digital assets (e.g., photographs, signatures, voice recordings, fingerprints, biometric information, etc. of the original user) to impersonate the original user, either for financial gain or simply to disguise their actual identity by presenting themselves as the original user.

Regardless of the motivations of malicious third parties, authorized users (the owners of personal information) typically want to control access to their personal information and want to be able to identify and remove or limit the availability of any unauthorized usage, i.e., to perform “reverse identity searches” to locate unauthorized instances of their own personal information. However, the ability to locate and detect unauthorized usages of digital personal information, i.e., a reverse-identity search, is beyond the capabilities of most users, as such searches requiring specialized computer and network hardware to digitize their personal information and search across the vastness of the Internet for matching occurrences of that information.

While commercial services are available to perform such searches on behalf of authorized users, such known services are not without significant drawbacks. For example, in order to search for a particular digital asset of an authorized user, the user must provide a copy of that asset to the search service so that the service knows what to search for, i.e., the user must provide a digital copy of the photograph, signature, voice, biometric, etc. to be searched. Therefore, in order to perform the search, the authorized user must disclose the personal information or digital asset to the search service and the search service will know the actual identity of the user and the content of the digital asset. And, upon performing the search, the search service will likely obtain additional personal information associated with the authorized user, such as where (the URLs, IP addresses, websites, etc.) the digital asset was located and potentially other information belonging to the authorized user. Thus, the search process itself may actually further expose the authorized user's personal information and/or digital assets.

Thus, it can be seen that there remains a need in the art for systems and methods that allows a user to search for unauthorized or unwanted digital assets online while preserving the user's privacy.

### SUMMARY

The present invention is directed to systems and methods for maintaining user privacy in searching for unauthorized instances of their personal information residing on computers or storage devices connected to a network or group of networks, while maintaining the privacy of the user and without exposing the user's personal information to the operators of the systems performing the searches.

As used herein, the term “digital assets” refers to personal information in digital form, including, but not limited to: photographs (e.g., in .jpg, .png, or other digital format), documents (e.g., in Word, .pdf, .xls, or other digital formats), video recordings (e.g., in .mp4, .avi, or other digital formats), sound recordings (e. g, in. mp3, .wav or other digital formats), biometric data (e.g., digitally encoded signatures, fingerprints, or other biometric data), and any other digitally encoded personal information. And, as used herein, “user” and “authorized user” indicates the owner, or someone authorized by the owner, of one or more digital assets.

In one exemplary embodiment, a system for searching for personal information while maintaining user privacy comprises a secure server system having one or more processors, storage, and memory. The server system further includes data encryption hardware and software to allow secure storage of data and information as well as communications hardware and software to allow the server to communicate over wide area and local networks.

In one embodiment, an authorized user seeking to search one or more networks (such as the Internet) for instances of one or more digital assets belonging to the user is granted access to the server system and uploads the digital asset to the server system where the uploaded digital asset is stored in a secure, encrypted portion of the server system storage such that only the authorized user can view the encrypted digital asset, with no unencrypted access to the digital asset available to the operator of the server system.

For each digital asset provided by the authorized user, the server system generates a search query and performs a search of the network (i.e., the Internet) for digital assets that match the authorized user's digital asset by computing a threshold distance between each located digital asset and the authorized user's original digital asset, where the threshold distance is indicative of the similarity between the two digital assets being compared. If the computed threshold distance is within an acceptable threshold, or threshold range, for that specific digital asset, then the located digital asset is considered a match, and a copy of the located digital asset and its location (e.g., URL, IP address, website) is saved in the authorized user's allocated secure storage for later review by the authorized user. Upon identification of an unauthorized copy of a digital asset, an authorized user may seek removal of the unauthorized copy by the host or operator of the URL, IP address, or website at which the unauthorized copy was located.

The acceptable threshold (or threshold range) to determine if a located copy of a digital asset is a match to an original digital asset is calculated based on one or more characteristics of the original digital asset, such as the digital asset type (e.g., photograph, audio, or biometric signature), the size of the original digital asset file, the encryption type of the original digital asset file, and the like.

It should be understood that the operator of the server system does not have access to unencrypted versions of the authorized user's original digital assets, nor does the operator have access to the search query generated by the server system, or to any of the search results (i.e., the located assets and their URLs) located in the search. Thus, the system and method of the present invention provide for complete user privacy and does not expose a user's personal information to the operator of the server system while allowing a user to search the Internet for unauthorized instances of personal information.

In some embodiments, the server system includes one or more privacy enhancing technologies (PETs) that support secure function evaluation over encrypted data allowing the operator of the server system to perform operations on the authorized user's digital assets without the ability to access or disclose an unencrypted version. In some embodiments, the PETs may include fully homomorphic encryption (FHE), secure multi-party computation (MPC), trusted execution environments (TEEs), and differential privacy (DP).

In some embodiments, the server system implements methods such as Euclidian computation, Hamming distance, and cosine similarity to compute the threshold distance between an authorized user's digital asset and a located digital asset without exposing actual data from the authorized user's digital asset(s). In further embodiments, the server system may employ function secret sharing (FSS) with additive secret sharing for privacy-preserving cosine similarity computation and comparison with the desired threshold value. In still further embodiments, the server system may use fully homomorphic encryption (FHE) for calculating Hamming distance in ciphertext or encrypted data.

In additional embodiments, one or more server systems may be employed to collaboratively perform operations on encrypted data provided by the authorized user, using cryptographic technology such as two-party computation (2PC) to ensure that an authorized user retains sole access to the search comparison results.

The details of one or more exemplary embodiments are set forth in the accompanying drawings and the description below. Other features and advantages will be apparent from the description and drawings, and from the claims.

### BRIEF DESCRIPTION OF THE FIGURES

FIG. 1 is a block diagram of a system for conducting searches for digital assets while maintaining user privacy in accordance with an exemplary embodiment of the present invention.

FIG. 2 is a flow diagram of the operation of the system for conducting searches for digital assets while maintaining user privacy in accordance with an exemplary embodiment of the present invention.

FIG. 3 is a flow diagram of a method of performing searches for digital assets while maintaining user privacy in accordance with an exemplary embodiment of the present invention.

FIG. 4 is a block diagram of a computerized system for conducting searches for digital assets while maintaining user privacy in accordance with an exemplary embodiment of the present invention.

### DETAILED DESCRIPTION

In the following detailed description of example embodiments, reference is made to specific example embodiments by way of drawings and illustrations. These examples are described in sufficient detail to enable those skilled in the art to practice what is described and serve to illustrate how elements of these examples may be applied to various purposes or embodiments. Other embodiments exist, and logical, mechanical, electrical, and other changes may be made. Features or limitations of various embodiments described herein, however important to the example embodiments in which they are incorporated, do not limit other embodiments, and any reference to the elements, operation, and application of the examples serve only to define these example embodiments. Features or elements shown in various examples described herein can be combined in ways other than shown in the examples, and any such combinations is explicitly contemplated to be within the scope of the examples presented here. The following detailed description does not, therefore, limit the scope of what is claimed.

Most people have a large digital footprint across the Internet, comprised of various information associated with that person. In addition to publicly available information such as address and telephone number listings, most users also have large amounts of personal information that they have shared, uploaded, or transmitted over the Internet. For example, people commonly post photographs, videos, and recordings to social media websites, send emails and messages, and conduct business using digital signatures, digital fingerprints, and other biometric information. While social media sites often implement prohibitions or restrictions to other users and third parties against downloading others'posted information, those sites security measures are often inadequate and multiple workarounds are available to allow others to access and download an authorized user's posted information such as photos, videos, and the like.

In addition to voluntarily posted personal information, an authorized user's personal information may be illicitly obtained via a hacking or phishing scheme or obtained through other nefarious means. Once obtained, that third party may post or distribute that information across the internet without the authorized user's consent or knowledge.

Once such unauthorized copies are uploaded, posted, or made available on the Internet, most users lack the technical knowledge and the equipment necessary to search the Internet to locate and/or remove any such unauthorized copies. While search services are available to assist in locating unauthorized instances of a user's digital assets, such searches require a user to disclose the contents of the digital asset to the search service and permit the search service to see the results of the search, which will likely include additional personal information belonging to the authorized user.

Embodiments of the present invention as described herein provide for systems and methods for maintaining user privacy in conducting searches for an authorized user's personal information and digital assets.

In one exemplary embodiment, a system for searching for digital assets belonging to an authorized user while maintaining the user's privacy comprises a secure server system having one or more processors, storage, and memory. The server system further includes data encryption hardware and software to allow secure storage of data and information as well as communications hardware and software to allow the server to communicate over wide area and local networks.

An authorized user seeking to search one or more networks (such as the Internet) for instances of one or more digital assets belonging to the user is granted access to the server system via a user device and uploads the digital asset to the server system where the uploaded digital asset is stored in a secure, encrypted portion of the server system storage such that only the authorized user can view the encrypted digital asset, with no unencrypted access to the digital asset available to the operator of the server system.

For each digital asset provided by the authorized user, the server system generates a search query and performs a search of the network (i.e., the Internet) for digital assets that match the authorized user's digital asset by computing a threshold distance between each located digital asset and the authorized user's digital asset. If the computed threshold distance is within a desired threshold, or threshold range, then the located digital asset is considered a match, and a copy of the located digital asset and its location (e.g., URL) is saved in the authorized user's allocated secure storage for later review by the authorized user.

The operator of the server system does not have access to unencrypted versions of the authorized user's digital assets, nor does the operator have access to the search queries generated by the server system, or to any of the search results (i.e., the located assets and their URLs, IP addresses, etc.) located in the search, thus, the authorized user's personal information is not further compromised by performing the search.

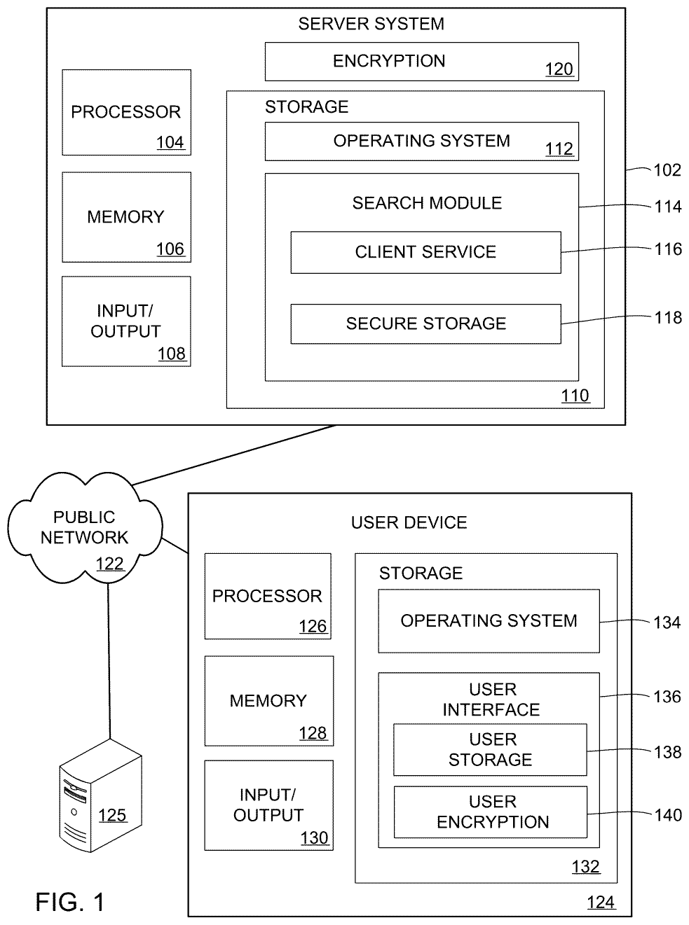

Looking first to FIG. 1, a block diagram of a system for facilitating searching for digital assets belonging to an authorized user while maintaining the user's privacy in accordance with an exemplary embodiment of the present invention is depicted. In this embodiment the server system 102 includes a processor 104 operable to execute computer program instructions and a memory 106 operable to store information such as program instructions and other data while the server system 102 is operating. The server system exchanges electronic data, encrypts data, receives input and information from a user, performs searches for digital assets belonging to the user, and performs other such communications and input/output operations via input/output 108.

Storage 110 may include non-transitory, non-volatile memory that stores program instructions including an operating system 112 that provides an interface between software or programs available for execution and the hardware of the server system and manages other functions such as access to input/output devices. The storage 110 also stores program instructions and other data for a secure search module 114, including client service 116 and user secure storage 118. The server system 102 further includes encryption module 120 which comprises hardware and software operable to perform encryption and decryption of data on the server system 102, including encryption of user secure storage 118 such that information stored in the user secure storage 118 (such as digital assets belonging to the user) may be uploaded, downloaded, and viewed by the authorized user and may be accessed for performing a search by the operator of the server system 102—however the encrypted information stored in the user secure storage 118 may not be viewed or decrypted by the operator of the server system.

The server system 102 is also coupled via a public network 122, such as the Internet, to one or more user devices 124, such as a user's smartphone or other remote client computerized device 125, with communication to and from the server system 102 facilitated by input/output 108 on the server system.

The user device 124 is preferably a computer, smartphone, tablet, laptop, or other smart device operable to communicate with other computerized devices over the network to allow the user to communicate with others and to access websites, web pages, accounts, and the like. One or more communications paths within the user device 124 allow the user device to enable a user to upload digital assets from the user device 124 to the server system 102 (e.g., to the encrypted user secure storage 118) or to communicate with other devices, such as server system 102, via a user interface 136 such as a web browser.

User device 124 preferably includes a processor 126, a memory 128, and input/output 130 including various sensors and components such as a camera, a Global Positioning System (GPS) receiver, a speaker and a microphone, and other such components as may be found in personal computers, smartphones, and the like. Storage 132 stores an operating system 134 and program information such as user interface 136 that in operation may be loaded into memory 128 and executed via processor 126 to perform various functions as described herein. The user interface 136 is preferably operable to provide user communication via a web browser to allow the user to access server system 102 and to upload, download, and otherwise communicate with the server system. User storage 138 provides non-transitory storage space for user data, including the user's digital assets such as photographs, videos, sound recordings, and biometric data. User encryption 140 operates in conjunction with the processor 126 to provide data encryption and decryption capabilities to the user interface 136 and the user storage 138.

In operation, the server system 102 implements via the processor 104 and hardware a search module 114 having a client service app 116 that facilitates communication with the user device 124, and a secure storage 118 configured to receive and store information from the user device 124, such as the personal information or digital assets for which the user wants to target a search of the Internet to locate unauthorized instances of.

For example, a user may have digital copies of photographs, recordings, or biometric data stored in user storage 138 on user device 124 that he or she wants to search the Internet for to determine if there are any unauthorized instances of that information. On user device 124 the stored digital assets may be either encrypted or unencrypted via user encryption 140 hardware and software.

For each of the digital assets to be searched, the user preferably associates a desired tolerance value for determining a match to that digital asset—i.e., how closely does a located asset have to match the original digital asset in order for it to be considered a copy of the original. The tolerance value thus allows the search to identify slightly altered or modified versions of an original digital asset.

From user device 124, a user uploads the desired digital assets to server system 102 for searching. Communication between the user device 124 and the server system 102 is facilitated between input/output 130 of the user device and input/output 108 of the server system, with the input/output on each implementing the appropriate communications protocols.

At server system 102, the digital assets are received and stored on secure storage 118, an encrypted storage device (or portion of a storage device) dedicated to storage of information for the user. With the digital assets stored on the encrypted user secure storage 110, the operator of the server system 102 is prevented from viewing the stored digital assets.

With the digital assets to be searched store in the user's secure storage 118, and with a tolerance value provided by the user for each of the digital assets, the server system 102 generates a search query for each digital asset and performs a search of the Internet for matching instances of each digital asset (i.e., for instances that match the original digital asset within the user's specified tolerance value). For each matching instance located, the server system captures the matching instance (e.g., the webpage, posting, file, or other matching digital asset) along with the location of that matching digital asset (e.g., URL, IP address, etc.). The located information is stored in the user secure storage 118 on the server system 102. And, because the user secure storage 118 is encrypted, the operator of the server system cannot see the located matching digital assets or other captured information or their location, nor can the operator of the server system see the original digital assets or the search queries generated by the server system in performing the searches. Thus, the search for a user's digital assets is performed without the user having to disclose any personal information to the operator of the server system, and without the operator of the server system having any access to view the user's original digital assets or any of the information located in the searches.

In preferred embodiments, the server system includes and/or implements one or more privacy enhancing technologies (PETs) that support secure function evaluation over encrypted data. The implemented PETs allow the operator of the server system 102 to perform operations on the authorized user's digital assets without the ability to access or disclose an unencrypted version. For example, in some embodiments, the PETs may include fully homomorphic encryption (FHE), secure multi-party computation (MPC), trusted execution environments (TEEs), and differential privacy (DP).

In determining the “closeness” of a located digital asset to the user's original digital asset, the server system 102 preferably implements methods such as Euclidian computation, Hamming distance, and cosine similarity to compute a threshold distance between an authorized user's digital asset and a located digital asset without exposing actual data from the authorized user's digital asset(s). In preferred embodiments, the computed threshold distance is compared to a desired threshold, or threshold range—if the computed threshold distance is within that threshold or range then the located digital asset is considered a match to the authorized user's original digital asset.

The desired threshold, or threshold range, is independently determined by the server system for each digital asset being searched, based on various characteristics of the digital asset. For example, the desired threshold may be based on the type of digital asset being searched (e.g., photo, biometric signature, etc.), the size of the digital asset file, and the expected or estimated number of similar assets to be located in a search. Thus, the desired threshold for determining a match is dynamic, and may vary between different types of digital assets and even among comparable digital assets.

In other embodiments, the server system may employ function secret sharing (FSS) with additive secret sharing for privacy-preserving cosine similarity computation and comparison with the desired threshold value. In still further embodiments, the server system may use fully homomorphic encryption (FHE) for calculating Hamming distance in ciphertext or encrypted data.

In additional embodiments, one or more server systems such as server system 102 may be employed to collaboratively perform operations on encrypted data provided by the authorized user, using cryptographic technology such as two-party computation (2PC) to ensure that an authorized user retains sole access to the search comparison results.

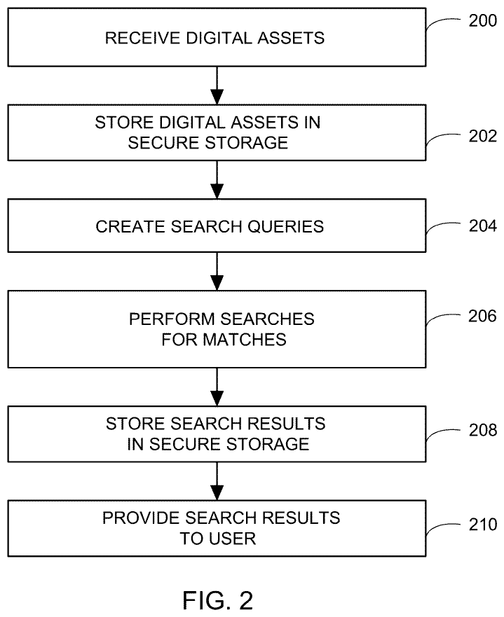

Turning to FIG. 2, a flow diagram of the operation of server system 102 in implementing a reverse personal information search while maintaining user privacy in accordance with an exemplary embodiment of the present invention is depicted.

At block 200, the server system 102 receives one or more digital assets from an authorized user

At block 202, the server system stores the authorized user's digital assets in a secure storage device, or portion of a storage device, in the server. The user's secure storage is preferably encrypted using encryption hardware and software on the server system such that the operator of the server system cannot view the user's personal information/digital assets.

At block 204, for each digital asset to be searched, the server assembles a search query using the digital asset and an associated threshold value, or threshold range, determined by the server system for each digital asset. In some embodiments, the search query may be stored in the user's secure storage on the server system.

At block 206, the server system performs a search for each query (i.e., a search for each digital asset as requested by the user) by searching locations on the Internet (or other network on which the search is being performed) for matches to the digital asset being searched. Matches to the digital asset being searched are preferably determined by Euclidian computation, Hamming distance, cosine similarity, and other known search schemes and protocols to compute a threshold distance between an authorized user's digital asset and a located digital asset without exposing actual data from the authorized user's digital asset(s).

It should be understood that the computed threshold distance in determining a match is not the same parameter as the threshold value or threshold range used to determine a match. The threshold distance is a value computed during the search process in determining how similar an original digital asset is to a digital asset located in the search, while the desired threshold or threshold range is a desired level of allowable difference between an original digital asset and a potential unauthorized copy of that asset.

It should be understood that the search process may involve multiple simultaneous searches of multiple branches of the network being searched, and may be performed by multiple processors on single server system or by multiple server systems simultaneously, with the separate search results aggregated into a single result.

At block 208, any matches to the search queries are stored in the user's secure storage on the server system. The stored information preferably includes the located digital assets and the location at which the digital asset was located (URL, IP Address, etc.). In some embodiments the stored information may include additional information related to the located digital asset and/or location, such as a copy of the entire webpage or website on which the digital asset was located, information related to the ownership of the website, or other information associated with the located digital asset.

As described previously, the information located in the searches and stored in the user's secure storage is encrypted and is not viewable by the operator of the server system, thus preserving the user's privacy.

At block 210, the user may access the search results by communicating with the server system and accessing the user secure storage, such as via a web browser, to review the search results.

Thus, the server system conducts the reverse identify search (a search for the authorized user's personal information) and provides results to the user without exposing any additional private information to the operator of the server system.

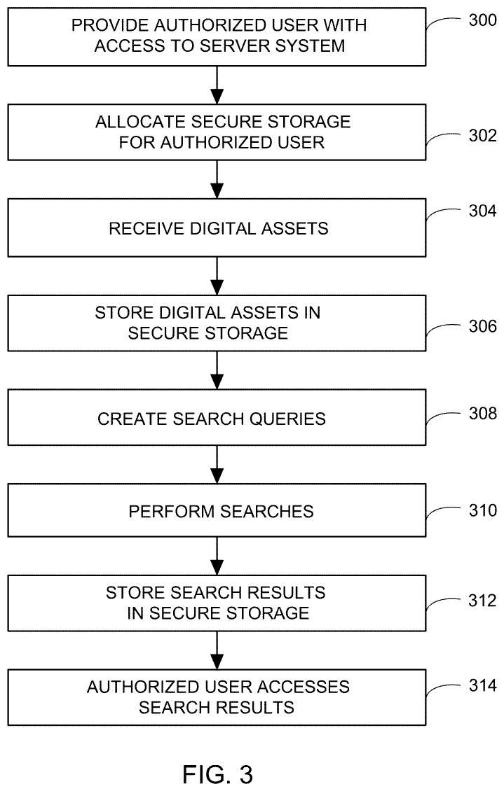

With the operation of the server system set forth, turning to FIG. 3, a flow diagram of an exemplary process of a user requesting a reverse identity search and a server system performing the search in accordance with an exemplary embodiment of the present invention is depicted.

Beginning at block 300, the server system 102 provides an authorized user (i.e., one who wants to perform a reverse-identity search to locate copies of digital assets on the Internet or other network) with access to the server system.

At block 302, the server system 102 allocates secure storage associated with the authorized user. As discussed above, the server system encrypts the user's secure storage so that only the authorized user my access and unencrypt stored data. Thus, even the operator of the server system cannot view the user's digital assets stored in the secure storage area.

At block 304, the authorized user uploads, and the server system 102 receives, one or more digital assets that the user wants to search for.

At block 306 the authorized user's digital assets are stored in the user's secure storage area on the server system 102.

At block 308, the server system 102 creates a search query for each digital asset to be searched. Each search query incorporates a desired threshold for how similar a digital asset located in the search must be to a user's original digital asset in order to be considered a match.. In some embodiments the desired threshold value may be between one and five percent such that located assets much resemble an original digital asset between at least ninety-five to ninety-nine percent in order to be considered a match.

At block 310, the server system performs multiple searches simultaneously across the Internet to locate assets that match the original asset within the desired tolerance. Matches to the digital asset being searched are preferably determined by Euclidian computation, Hamming distance, cosine similarity, and other known search schemes and protocols to compute a threshold distance between an authorized user's digital asset and a located digital asset without exposing actual data from the authorized user's digital asset(s). It should be understood that the searches may be performed by multiple processors on the server system 102, and/or that multiple server systems 102 may be employed to simultaneously perform the searches.

At block 312, the results of the search, including any located assets and their locations (URL, IP address, etc.) are stored in the user's secure storage. As discussed above, the search results are not viewable or reviewable by the operator of the server system, only the authorized user has access to the user secure storage.

At block 314 the user may be notified that the search is complete and that the search results are available for download and/or viewing by the authorized user.

Thus, as just described, the system and method as described allow an authorized user to conduct reverse-identity searches on a network to locate unauthorized instances of one or more digital assets belonging to the authorized user. The user's uploaded digital assets are store securely in an encrypted storage area on the server system 102 such that the operator of the server system cannot view the user's digital assets and likewise cannot view the results of a search, so that the authorized user's privacy is completely protected during the entire search process.

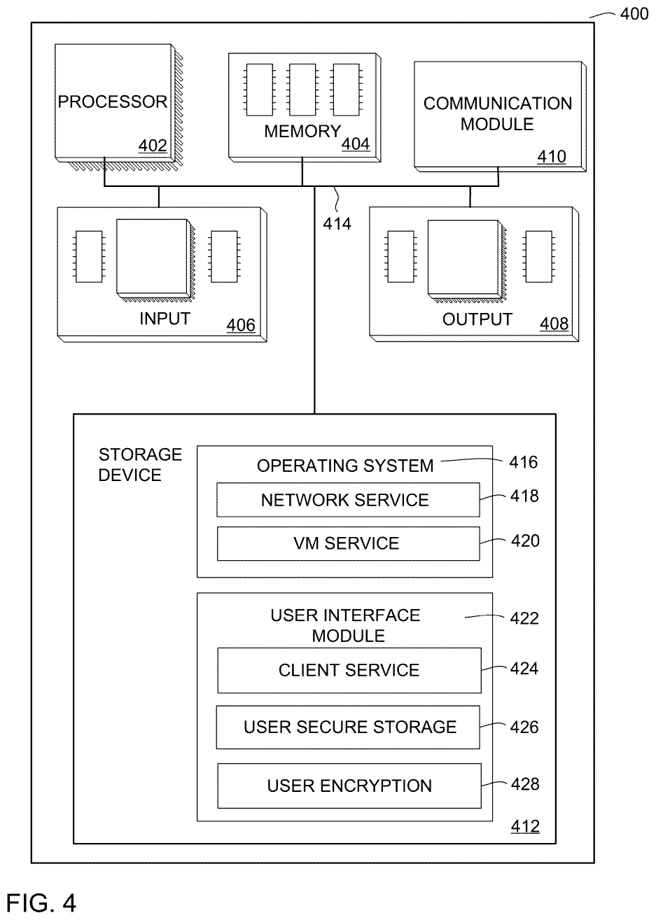

Finally, turning to FIG. 4, a computerized device 400 is depicted, such as a user device similar to user device 124 of FIG. 1, that allows an authorized user to access the server system 102 to upload digital assets for searching and to access and/or download search results once the search is completed.

The operation of using the computerized user device 400 in accessing the server system 102 is similar to that as described above with respect to the operation of the system of FIG. 1, with the user device preferably providing a web browser interface to allow a user to access the server system

While user device 400 is shown as a standalone computing device, computing device 400 may be any component or system that includes one or more processors or another suitable computing environment for executing software instructions in other examples, and need not include all of the elements shown here.

As shown in the specific example of FIG. 4, computing device 400 includes one or more processors 402, memory 404, one or more input devices 406, one or more output devices 408, one or more communication modules 410, and one or more storage devices 412. Computing device 400 in one example further includes an operating system 416 executable by computing device 400. The operating system includes in various examples services such as a network service 418 and a virtual machine service 420 such as a virtual server. One or more applications, such as a user interface module 422 are also stored on storage device 412, and are executable by computing device 400.

Each of components 402, 404, 406, 408, 410, and 412 may be interconnected (physically, communicatively, and/or operatively) for inter-component communications, such as via one or more communications channels 414. In some examples, communication channels 414 include a system bus, network connection, inter-processor communication network, or any other channel for communicating data. Applications such as user interface module 422 and operating system 416 may also communicate information with one another as well as with other components in computing device 400.

Processors 402, in one example, are configured to implement functionality and/or process instructions for execution within computing device 400. For example, processors 402 may be capable of processing instructions stored in storage device 412 or memory 404. Examples of processors 402 include any one or more of a microprocessor, a controller, a digital signal processor (DSP), an application specific integrated circuit (ASIC), a field-programmable gate array (FPGA), or similar discrete or integrated logic circuitry.

One or more storage devices 412 may be configured to store information within computing device 400 during operation. Storage device 412, in some examples, is known as a computer-readable storage medium. In some examples, storage device 412 comprises temporary memory, meaning that a primary purpose of storage device 412 is not long-term storage. Storage device 412 in some examples is a volatile memory, meaning that storage device 412 does not maintain stored contents when computing device 400 is turned off. In other examples, data is loaded from storage device 412 into memory 404 during operation. Examples of volatile memories include random access memories (RAM), dynamic random access memories (DRAM), static random access memories (SRAM), and other forms of volatile memories known in the art. In some examples, storage device 412 is used to store program instructions for execution by processors 402. Storage device 412 and memory 404, in various examples, are used by software or applications running on computing device 400 such as user interface module 422 to temporarily store information during program execution.

Storage device 412, in some examples, includes one or more computer-readable storage media that may be configured to store larger amounts of information than volatile memory. Storage device 412 may further be configured for long-term storage of information. In some examples, storage devices 412 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 400, in some examples, also includes one or more communication modules 410. Computing device 400 in one example uses communication module 410 to communicate with external devices via one or more networks, such as one or more wireless networks. Communication module 410 may be a network interface card, such as an Ethernet card, an optical transceiver, a radio frequency transceiver, or any other type of device that can send and/or receive information. Other examples of such network interfaces include Bluetooth, 4G, LTE, or 5G, WiFi radios, and Near-Field Communications (NFC), and Universal Serial Bus (USB). In some examples, computing device 400 uses communication module 410 to communicate with an external device such as via public network 122 of FIG. 1.

Computing device 400 also includes in one example one or more input devices 406. Input device 406, in some examples, is configured to receive input from a user through tactile, audio, or video input. Examples of input device 406 include a touchscreen display, a mouse, a keyboard, a voice-responsive system, a video camera, a microphone, or any other type of device for detecting input from a user.

One or more output devices 408 may also be included in computing device 400. Output device 408, in some examples, is configured to provide output to a user using tactile, audio, or video stimuli. Output device 408, in one example, includes a display, a sound card, a video graphics adapter card, or any other type of device for converting a signal into an appropriate form understandable to humans or machines. Additional examples of output device 408 include a speaker, a light-emitting diode (LED) display, a liquid crystal display (LCD), or any other type of device that can generate output to a user.

Computing device 400 may include operating system 416. Operating system 416, in some examples, controls the operation of components of computing device 400, and provides an interface from various applications such as user interface module 422 to components of computing device 400. For example, operating system 416, in one example, facilitates the communication of various applications such as user interface module 422 with processors 402, communication module 410, storage device 412, input device 406, and output device 408. Applications such as user interface module 422 may include program instructions and/or data that are executable by computing device 400. As one example, user interface module 422 uses client service 424 to interface between the user secure storage 426 on the device and the user encryption 428 to allow a user to securely encrypt data and digital assets stored on the device 400 to protect their privacy.

Although specific embodiments have been illustrated and described herein, any arrangement that achieves the same purpose, structure, or function may be substituted for the specific embodiments shown. This application is intended to cover any adaptations or variations of the example embodiments of the invention described herein. These and other embodiments are within the scope of the following claims and their equivalents.

1. A method for performing searches for personal information on a network while preserving user privacy, comprising:
receiving an original digital asset from an authorized user;
storing the received original digital asset in a secure storage medium;
assembling a search query to locate copies of the original digital asset;
executing the search query to perform a search for copies of the original digital asset located on a network;
aggregating and storing located copies of the digital asset and their network locations onto the secure storage medium; and
providing access to the secure storage medium and the contents thereof to only the authorized user.

2. The method for performing searches for personal information on a network while preserving user privacy of claim 1, wherein receiving an original digital asset from an authorized user comprises receiving an encrypted version of the digital asset.

3. The method for performing searches for personal information on a network while preserving user privacy of claim 1, wherein assembling a search query comprises incorporating information from the original digital asset and a desired threshold value to define parameters of the search.

4. The method for performing searches for personal information on a network while preserving user privacy of claim 3, further comprising employing function secret sharing (FSS) with additive secret sharing for privacy-preserving cosine similarity computation and comparison with the desired threshold value.

5. The method for performing searches for personal information on a network while preserving user privacy of claim 3, further comprising:
employing fully homomorphic encryption (FHE) for calculating a Hamming distance between the original digital asset and a located copy of the digital asset.

6. The method for performing searches for personal information on a network while preserving user privacy of claim 1, wherein matches of located digital assets to the original digital asset are determined by Euclidian computation, Hamming distance, cosine similarity, or combinations thereof.

7. The method for performing searches for personal information on a network while preserving user privacy of claim 1, wherein performing the search for copies comprises computing a threshold distance between the original digital asset and a located digital asset.

8. The method for performing searches for personal information on a network while preserving user privacy of claim 1, wherein network locations comprises URLs, IP addresses, or combinations thereof.

9. The method for performing searches for personal information on a network while preserving user privacy of claim 1, further comprising:
instigating removal from the network, by an authorized user, of an unauthorized copy of an original digital asset.

10. The method for performing searches for personal information on a network while preserving user privacy of claim 1, further comprising:
using privacy enhancing technologies (PETs) that support secure function evaluation over encrypted data to allow a searcher to perform operations on the authorized user's digital assets without the ability to access or disclose an unencrypted version.

11. The method for performing searches for personal information on a network while preserving user privacy of claim 10, wherein the privacy enhancing technologies (PETs) comprise fully homomorphic encryption (FHE), secure multi-party computation (MPC), trusted execution environments (TEEs), differential privacy (DP), or combinations thereof.

12. A server system, comprising:
a processor and a non-volatile storage, the non-volatile storage comprising instructions that when executed on the server system cause the server system to:
receive an original digital asset from an authorized user;
store the received original digital asset in a secure storage medium;
assemble a search query to locate copies of the original digital asset;
execute the search query to perform a search for copies of the original digital asset located on a network;
aggregate and store located copies of the digital asset and their network locations onto the secure storage medium; and
provide access to the secure storage medium and the contents thereof to only the authorized user.

13. The server system of claim 12, wherein the original digital asset received from an authorized user comprises an encrypted version of the digital asset.

14. The server system of claim 12, further comprising instructions that when executed on the server system cause the server system to:
assemble the search query by incorporating information from the original digital asset and a deisred threshold value to define parameters of the search.

15. The server system of claim 14, further comprising instructions that when executed on the server system cause the server system to implement function secret sharing (FSS) with additive secret sharing for privacy-preserving cosine similarity computation and comparison with the desired threshold value.

16. The server system of claim 12, further comprising instructions that when executed on the server system cause the server system to implement fully homomorphic encryption (FHE) for calculating a Hamming distance between the original digital asset and a located copy of the digital asset.

17. The server system of claim 12, further comprising instructions that when executed on the server system cause the server system to determine matches of located digital assets by Euclidian computation, Hamming distance, cosine similarity, or combinations thereof.

18. The server system of claim 12, wherein performing the search for copies comprises computing a threshold distance between the original digital asset and a located digital asset.

19. The server system of claim 12, wherein network locations comprises URLs, IP addresses, or combinations thereof.

20. The server system of claim 12, further comprising instructions that when executed on the server system cause the server system to instigate removal from the network of an unauthorized copy of an original digital asset.
